(19) United States
(12) Patent Application Publication
(10) Pub. No.: US 2004/0120045 A1
(43) Pub. Date: Jun. 24, 2004

(54) Reflective device

(76) Inventor: Gordon Matthew John Haines, Cornwall (GB)

Correspondence Address: STITES & HARBISON PLLC, 1199 NORTH FAIRFAX STREET, SUITE 900, ALEXANDRIA, VA, 22314, US

(21) Appl. No.: 10/474,752

(22) PCT Filed: Apr. 11, 2002
(86) PCT No.: PCT/GB02/01710

(30) Foreign Application Priority Data
Apr. 12, 2001 (GB) 0109253.5
Mar. 13, 2002 (GB) 0205940.0

(51) Int. Cl. G02B 5/128; G02B 5/132

(52) U.S. Cl. 359/538; 359/543

(57) ABSTRACT

A reflective device has a fluorescent sheet with reflective material, e.g. in the shape of strips, attached thereto, for mounting on a vehicle. The sheet has tabs extending from it for positioning in a closable aperture of the vehicle. The tabs may have rods to prevent the tabs from being pulled out of the aperture when closed. Tape strips may provide additional means of attachment. Tape loops and bungy strips provide means for fixing the sheet to lower portions of the vehicle. The sheet may be in the form of a hollow cylindrical tube. The reflective device may also be a sock which fits over a wing mirror, or a sheet with opposing edges that can be temporarily connected to form a sleeve which fits over parts of the vehicle.

### BACKGROUND OF THE INVENTION

1. Field of the Invention

The present invention relates to a reflective device for mounting on a vehicle or part of a vehicle.

2. Summary of the Prior Art

When a vehicle stops on an unlit, or poorly lit, section of road, it is desirable to be able to make other users of the road aware of the presence and position of the stopped vehicle, and thereby reduce the risk of accidents. This may be accomplished by active methods, which work by emitting light, such as use of hazard warning lights, or by passive methods, which work by reflecting light from another source, e.g. headlights of an approaching vehicle, such as use of a “red triangle” placed a distance from the vehicle in the direction from which other vehicles are approaching, or the reflective elements in the rear light assemblies of most vehicles.

Active methods are better at attracting the attention of other drivers, and since they are usually mounted on, or part of, the vehicle from which they draw their power, they also serve to indicate the position of the vehicle. However, in order to operate, active methods require a power supply, normally the battery and/or engine of the vehicle, and this is unpractical for situations where the vehicle may be stationary for some time, or where failure of the power source itself has caused the vehicle to stop.

Passive methods such as the “red triangle” suffer from the disadvantage that they are often hard to see, as they can only reflect a small portion of the incoming light. For this reason, they normally need to be placed some distance away from the vehicle in order to warn oncoming traffic. Moreover, these methods are often unstable, and can easily be blown over by the wind.

Emergency service vehicles, which are often required to stop on the road, in all conditions, use a high visibility paint scheme in addition to any lights. However, such a paint scheme is permanent, and therefore undesirable for the normal motorist.

### SUMMARY OF THE INVENTION

The present invention seeks to provide a highly visible reflective device which can be easily stored and, in use, attached or affixed to the outside of a vehicle or part of a vehicle.

Therefore, at its most general, the present invention provides a reflective device, for mounting on a vehicle or part of a vehicle, at least substantially manufactured from, or covered in, fluorescent material, and having affixed to, or incorporated in, the fluorescent material reflective material defining at least one predetermined shape, and having means for securing the device to the vehicle.

According to a first aspect of the present invention, there is provided a reflective device for mounting on a vehicle or part of a vehicle, comprising: a sheet of fluorescent material; reflective material defining at least one predetermined shape affixed to or incorporated in said sheet (for example by stitching or adhesive); and at least one tab extending from said sheet, the tab being used to secure the sheet in a closable aperture of said vehicle or part of a vehicle. Thus when the sheet is secured to the vehicle, the face of the sheet with the reflective material is exposed, so that the vehicle is made more visible.

The reflective material is preferably one or more strips or stripes, but other shapes are possible such as circles and triangles.

This closable aperture may be the boot, door or window of the vehicle, the sheet being held in place by closing the boot, door or window so as to trap the or each tab. The sheet may be padded to help weigh down the device and prevent it from being blown by the wind, wherein the reverse face of the sheet (usually in contact with the car) is exposed. To cater for the case of strong winds, both faces of the sheet may be fluorescent and have reflective material defining at least one predetermined shape attached to each face, so that the device performs its function even when the reverse face of the sheet is exposed. Assuming that the shapes are strips, it is preferable to attach fewer reflective strips to the reverse face of the sheet. Preferably, however, the sheet may also be provided with further fixing means, for example tape strips which can be tied around the lock attachment of the boots of some cars, and/or means for attaching the side of the sheet opposite to the tab(s) to the lower portions or underside of the vehicle. These latter fixing means may include tape loops or metal or plastics eyes, to which rope or bungy straps may be attached, the other end of the rope or bungy strap being attached to, for example, the wheel hub or the wheel of the vehicle, or woven tape stitched or stuck onto the sheet and being of sufficient length to tie around, for example, the axle, wheel or wheel hub of the vehicle. In particular, tape strips may be attached to the centre of the other side of the sheet which can be tied around the towbar of the vehicle.

A rod or rods may also be inserted in or attached to the end of the tab(s), so as to prevent the possibility of the tab(s) being pulled out of the closed aperture. The tab(s) may be padded in the same way as the sheet also to prevent the possibility of them being pulled out of the aperture.

In a development of the present invention, the reflective device further comprises one or more support rings or discs and at least part of said sheet is formed into a hollow cylindrical shape, the cylindrical shape being supported by the one or more support rings or discs.

The support rings or discs can be made from any material that has sufficient rigidity to retain the cylindrical portion of the sheet in shape, and preferably are easy to attach to the sheet, for example, by stitching. If support rings are used, they can be attached to either the inside or the outside of the cylindrical portion. The support rings or discs are preferably provided at each end of the cylindrical portion and also at regularly spaced intervals along that portion. Alternatively the support rings or discs may be one or more solid or hollow cylindrical inserts which are present inside the majority, or even all, of the cylindrical portion of the sheet.

In this development, it is preferable that the or one of the shapes of reflective material is located on the cylindrical portion of the sheet, and at approximately 90 degrees angular separation from the point at which the tab(s) or the remainder of the sheet extends from the cylindrical portion.

To use the device, it is unrolled or unfolded and placed over the back or front of the vehicle, or alternatively over a door of the vehicle, with at least part of the tabs, and any rod or rods inserted in those tabs, inside the closable aperture. The aperture is then closed so as to trap the tabs, and the rods if present, inside the vehicle and secure the device. Further fixing means, if present, may be used to secure the device in the desired position.

However, in many situations it will be either unsafe or unpractical to attach a reflective device according to the first aspect of the present invention, for example if the vehicle has stopped on a busy road.

Therefore, according to a second aspect of the present invention, there is provided a reflective device for mounting on a vehicle or part of a vehicle, comprising: a sock of fluorescent material, the sock having an open end and a closed end; reflective material defining at least one predetermined shape affixed to or incorporated in said sock (for example by stitching or adhesive); and means for partially closing the open end of the sock.

The reflective material is preferably one or more strips or stripes, but other shapes are possible such as circles and triangles.

Preferably there are at least two reflective strips affixed or attached to the sock, being located on opposite sides of the sock. Preferably these strips run from the open end of the sock to the closed end. Alternatively, there may be only one strip which extends around the sock so that it is also present on both sides.

The closing means is preferably cord, for example made from polyester, which is threaded through the fabric at the open end of the sock, around the opening, and when pulled out of the fabric, partially closes the open end. Preferably this cord is also provided with a cord clasp which secures the open end in a partially closed state, by preventing the cord returning into the fabric.

This device can be easily placed over the wing-mirror of a vehicle, and secured, from inside that vehicle, and thereby allowing the occupant to affix a reflective device without leaving the vehicle.

However, some vehicles, particularly goods vehicles, have wing-mirror assemblies which are mounted on a bracket extending from the vehicle, and so it is not possible to use a reflective device according to the second aspect on those wing-mirrors.

Therefore, according to a third aspect of the present invention, there is provided a reflective device for mounting on a vehicle or part of a vehicle, comprising: a sheet of fluorescent material; reflective material defining at least one predetermined shape affixed to or incorporated in said sheet (for example by stitching or adhesive); fixing means located towards two opposing edges of the sheet, the two edges thereby being temporarily connectable to each other to form a sleeve.

The reflective material is preferably one or more strips or stripes, but other shapes are possible such as circles and triangles.

Preferably these fixing means comprise Velcro™ strips, with the hook strip being sewn onto one side of the sheet and the loop strip being sewn onto the other side of the sheet, such that when the sheet is formed into a sleeve, the hook strip and the loop strip interact to secure the sheet in the sleeve configuration.

Preferably the sheet is provided with at least two reflective strips, attached or affixed parallel to the sides where the fixing means are located, arranged such that when the sheet is formed into a sleeve, the reflective strips are located opposite each other.

This device can then be wrapped around a wing-mirror of a bracket type, and secured, again without the need for the occupant to leave the vehicle.

Although the various aspects of the invention discussed above are defined in terms of a reflective device, the present invention further includes use of such devices on a vehicle or part of a vehicle, methods of mounting such devices, and the vehicle when such a device is mounted on it. This applies to all three aspects of the invention.

### BRIEF DESCRIPTION OF THE DRAWINGS

Embodiments of the present invention will now be described with reference to the following drawings in which:

FIGS. 1a and 1b show the front and back view respectively of a reflective device according to the firt aspect of the present invention.

FIG. 2 is a drawing of a second reflective device according to the first aspect of the present invention;

FIG. 3 is a drawing of a third reflective device according to the first aspect of the present invention;

FIG. 4 is a drawing of a reflective device according to the second aspect of the present invention; and

FIG. 5 is a drawing of a reflective device according to the third aspect of the present invention.

### DETAILED DESCRIPTION

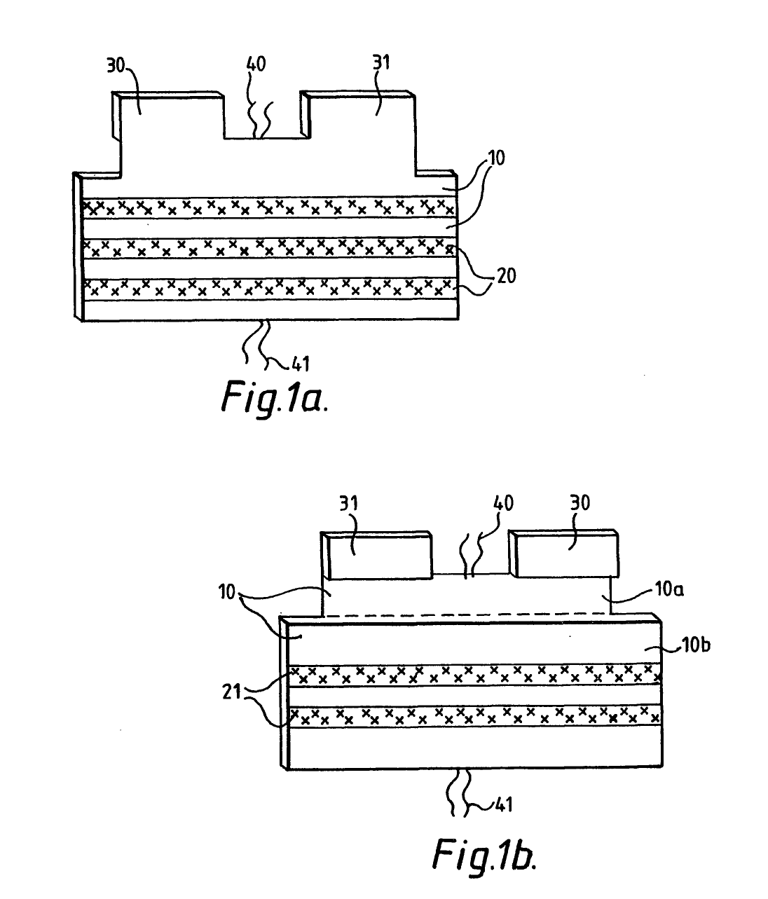

FIGS. 1a and 1b show a reflective device which can be attached to the boot or bonnet of a vehicle. The device comprises a sheet of fluorescent material 10, which may be any one of a number of products commonly used in high-visibility clothing, such as dyed 4 oz polyurethane (PU) coated nylon fabric. The sheet is approximately the same width as an average car.

Attached to the sheet by stitching or adhesive are a number of reflective strips 20, 21, which may be one of a number of such products commonly used in high-visibility clothing, such as Reflexite® or similar material. In this embodiment there are three reflective strips 20 on the front of the device, as shown in FIG. 1a, and two reflective strips 21 on the back of the device. Thus, whichever face of the sheet is exposed, the device will retain its function. Note that both sides of the sheet 10 are made of fluorescent material in this embodiment.

Two tabs 30 and 31 extend away from the sheet. As can be seen in both FIGS. 1a and 1b, the tabs 30, 21 and portion 10b of the sheet with reflective strips on are padded. The padding material may be foam, or a similar material, which still allows the sheet to be folded for storage, but gives the device some bulk which helps to weigh it down. The sheet 10 has an unpadded portion 10a which allows the tabs 30, 31 to be folded into the sheet without making the folded sheet too cumbersome.

Woven tape strips 40 and 41b are positioned in central positions along opposing edges of the sheet. The tape strips 40 can be used to tie the device to a lock attachment of the boot of a vehicle or alternatively tie the device to a point inside the boot or bonnet of the vehicle. Tape strips 41 can be used to tie the device to the tow bar of the vehicle, thus securing it in place.

Therefore, in normal operation, the device will be unfolded and placed such that the tabs 30 and 31 are trapped inside the boot or bonnet of the vehicle, with the sheet then being draped over the front or back of the vehicle. The device can then be further secured by using the woven tape strips 40 and 41. Thus, normally only one face of the sheet 10 will be displayed. The reverse face of the sheet also has reflective strips attached thereto. This caters for the case where the tape strips 41 become untied, or are deliberately left untied, as may be desirable in snow conditions thereby allowing movement of the sheet to keep the reflective surfaces as free of snow as possible. In this particular embodiment, there are two reflective strips 21 on the back face, and three reflective strips 20 on the front face.

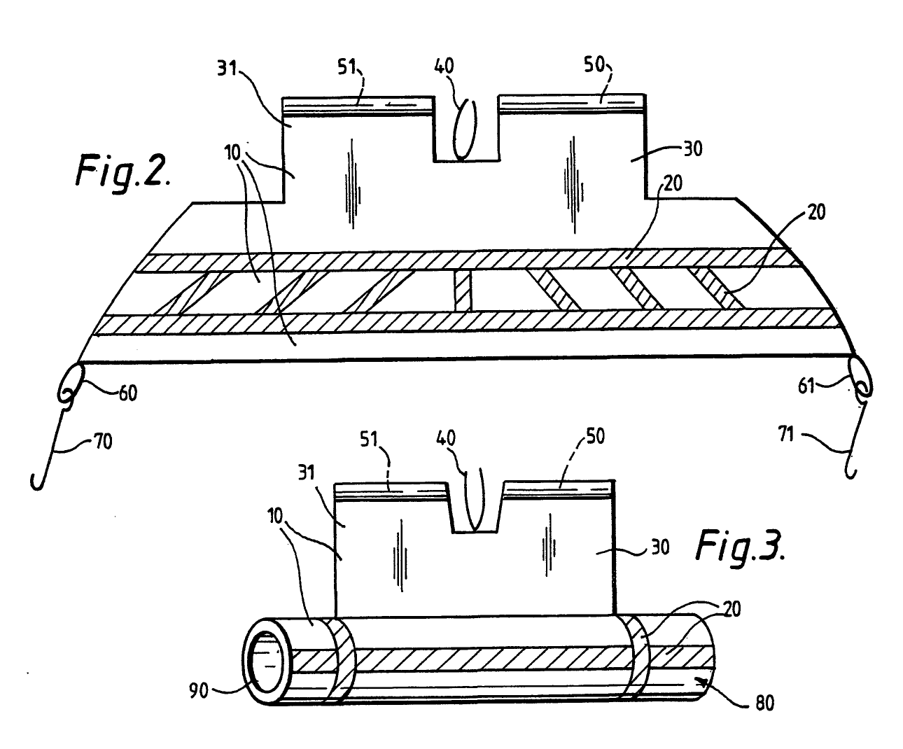

FIG. 2 shows another reflective device which can be attached to the boot or bonnet of a vehicle. It too comprises a fluorescent sheet 10, to which reflective strips 20 are attached or affixed.

Again, two tabs 30 and 31 extend from the sheet and end in a folded over section of fabric, into which rods 50 and 51, such as a length of pipe made from plastics or metal, are inserted.

Woven tape strips 40 are also attached to the sheet between the tabs which can be used to tie the device to a lock attachment of the boot of a vehicle or alternatively tie the device to a point inside the boot or bonnet of the vehicle.

Two woven tape loops 60 and 61 are located at the bottom corners of the device, providing attachment points for ropes or bungy straps 70 and 71 which in turn are securely fastened to a wheel hub, a wheel itself or some other anchor point on the side or underside of the vehicle.

Since the all of the device, apart from the rods 50 and 51, is made from material, it is easy to fold or roll-up the device for convenient storage in a vehicle.

For use, the device is unrolled or unfolded and placed such that rods 50 and 51 and at least part of the tabs 30 and 31 are inside the boot or bonnet. The boot or bonnet is then closed on the tabs, thus securing the device to the car. The device can be further secured and held in the desired position by using the woven tape strips 40 and/or ropes or bungy strips 70 and 71.

FIG. 3 shows another reflective device which can be attached to the bonnet or boot of the vehicle. It too comprises a fluorescent sheet 10, to which reflective strips 20 are stitched and has tabs 30 and 31, each ending in a folded over section of fabric into which rods 50 and 51 are inserted. Woven tape strips 40 for securing the device to the lock attachment of a boot are also provided.

In the embodiment shown in FIG. 3, part of the sheet has been formed into a hollow cylindrical portion 80 by attaching (stitching) the edge of the sheet opposite the tabs to the sheet at another point. Support rings 90 made from foam rubber are attached to the inside of the cylindrical portion 80 at regular intervals along its length.

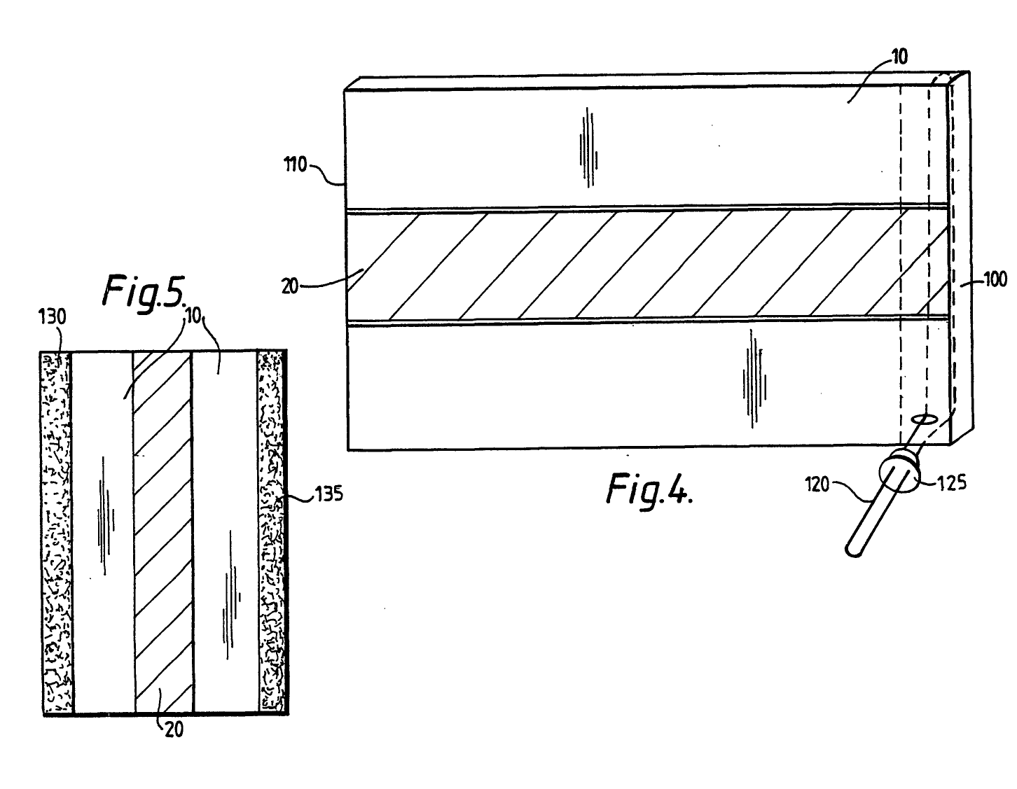

FIG. 4 shows a reflective device which can be used on the wing mirror or any similar projection of a vehicle. The device comprises a sheet of fluorescent material 10, formed, e.g. by stitching, into a sock with an open end 100 and a closed end 110. A strip of reflective material 20 is stitched onto each side of the device, running from the open end 100 to the closed end 110.

The open end is provided with a polyester cord 120 which passes through the fluorescent material 10, either via a series of holes, or through a passageway formed by a folded over section of fabric. Pulling the cord out of the fabric in a drawstring effect causes the open end of the device to partially close up, and cord clasp 125 secures the material in the partially closed position.

As all parts of the device are flexible, the device can be readily folded or rolled for easy storage.

In use the device is placed over the wing-mirror of the vehicle on the side on which other vehicles are likely to pass, in such a way that a reflective strip 20 is visible from each side, and the cord 120 is pulled tight and clasped to secure the device around the wing-mirror.

FIG. 5 shows another reflective device which can be used on the wing-mirrors or similar projections of vehicles, and especially in situations where the wing-mirror is mounted on a continuous bracket, as found on many goods vehicles.

The device comprises a sheet of fluorescent material 10, to which a reflective strip 20 is stitched. Two strips 130, 135 of Velcro™ or similar material are also stitched to the sheet, on different sides of the sheet, and also along opposite edges of the sheet. One of the strips is a hook strip and one is a loop strip. The device can therefore be wrapped around the wing-mirror to form a sleeve and fastened there by the interaction between the two strips. The two strips may alternatively be joined by buckles or other fastenings.

By attaching the Velcro™ strips perpendicular to the direction shown in the drawing, the sleeve can be adjusted to fit a number of differently sized wing-mirror assemblies. Further pairs of Velcro™ strips can be added to create a more secure fastening.

1. A reflective device for mounting on a vehicle or part of a vehicle, the device comprising:
a sheet of fluorescent material;
reflective material defining at least one predetermined shape affixed to or incorporated in one face of the sheet; and
at least one tab extending from the sheet,
such that in use, the device is securable to the vehicle by trapping the tab(s) in a closable aperture of said vehicle.

2. A reflective device according to claim 1 wherein the reflective material is at least one reflective strip.

3. A reflective device according to claim 1 or claim 2, having one or more support rings or discs, wherein at least part of the sheet is formed into a hollow cylindrical portion, the cylindrical portion being supported by the support rings or discs.

4. A reflective device according to claim 3, wherein the support rings or discs are in the form of a hollow cylindrical tube for inserting into the cylindrical portion of the sheet.

5. A reflective device according to either one of claims 2 or 3 as dependent on claim 2, wherein the or each of the reflective strips is located on the cylindrical portion of the sheet.

6. A reflective device according to claim 5, wherein the or each of the reflective strips are located at approximately 90° from the point at which the tabs or the remainder of the sheet extend from the cylindrical portion.

7. A reflective device according to any one of the preceding claims, wherein there is reflective material defining at least one further predetermined shape on the other face of the sheet.

8. A reflective device according to any one of the preceding claims having fixing means for attaching the sheet to the lower portion or underside of the vehicle, the fixing means extending from the sheet in a direction opposite to the tab(s).

9. A reflective device according to any one of the preceding claims, wherein the sheet and/or the tab(s) are padded.

10. A reflective device according to any one of the preceding claims, wherein a rod is inserted in or attached to the or each tab to prevent the tab(s) from being pulled out of the aperture when the aperture is closed.

11. A method of mounting a reflective device on a vehicle or part of a vehicle, the device comprising:
a sheet of fluorescent material;
reflective material defining at least one predetermined shape affixed to or incorporated in one face of the sheet; and
at least one tab extending from the sheet,
the device being mounted on the vehicle or vehicle part by trapping the tab(s) in a closable aperture of the vehicle or vehicle part.

12. A vehicle having a reflective device securely mounted thereon, the device comprising:
a sheet of fluorescent material;
reflective material defining at least one predetermined shape affixed to or incorporated in one face of the sheet; and
at least one tab extending from the sheet,
wherein the tab(s) are trapped in a closable aperture of the vehicle.

13. A reflective device for mounting on a vehicle or part of a vehicle, the device comprising:
a sheet of fluorescent material in the form of a sock, having an open end and a closed end;
reflective material defining at least one predetermined shape affixed to or incorporated in the sheet; and
means for partially closing the open end of the sock.

14. A reflective device according to claim 1 wherein the reflective material is at least one reflective strip.

15. A reflective device according to claim 14, having reflective strip(s) attached or affixed to opposite sides of the sock.

16. A reflective device according to either one of claims 14 or 15, wherein the reflective strip(s) run from the open end to the closed end.

17. A reflective device according to any one of claims 13 to 16, wherein the means for partially closing the open end of the sock is a cord threaded through the material at the open end.

18. A reflective device according to claim 17, wherein the open end is held partially closed by means of a cord clasp.

19. A reflective device for mounting on a vehicle or part of a vehicle, the device comprising:
a sheet of fluorescent material;
reflective material defining at least one predetermined shape affixed to or incorporated in the sheet; and
fixing means located towards two opposing edges of the sheet, the two edges thereby being temporarily connectable to each other to form a sleeve.

20. A reflective device according to claim 17, wherein the fixing means comprises Velcro™ strips.

21. A reflective device according to claim 17 or claim 20 wherein the reflective material is at least one reflective strip.

22. A reflective device according to claim 21, having at least one reflective strip running parallel to the sides of the sheet with the fixing means, the strips being arranged to be opposite one another when the sheet forms a sleeve.
